(19) United States
(12) Patent Application Publication
(10) Pub. No.: US 2018/0000169 A1
(43) Pub. Date: Jan. 4, 2018

(54) GARMENT FOR PROVIDING DISPLAY FUNCTION

(71) Applicant: BOUD CO. LTD, Seoul (KR)

(72) Inventors: Yun Wha LEE, Seoul (KR); Min Hong KIM, Chungcheongnam-do (KR); Mi So KWON, Gangwon-do (KR)

(21) Appl. No.: 15/541,465

(22) PCT Filed: Apr. 2, 2015
(86) PCT No.: PCT/KR2015/003293

§ 371 Date: Jul. 3, 2017

(30) Foreign Application Priority Data
Jan. 5, 2015 (KR) 10-2015-0000614

(51) Int. Cl. A41D 1/00; A41D 27/08; G09F 9/30; G09F 9/302

(52) U.S. Cl. CPC A41D 1/002; G09F 9/3023; A41D 27/085; G09F 9/301

(57) ABSTRACT

Disclosed are clothes for providing a display function. The clothes may include: a flexible display module including a predetermined number of light emitting diode elements disposed at a predetermined interval; a communication module which communicates with at least one of a user terminal and a control server, and receives at least one of a control signal and image data, the image data including at least one of still image data and video data; a control module which controls the flexible display module to output an image corresponding to h received image data in response to the received control signal or a control signal generated by the control module; and a memory module which stores at least one of an image that is displayable in the flexible display module and identification information of the clothes.

### TECHNICAL FIELD

The present disclosure relates to clothes, and more particularly, to clothes providing a display function, and a user terminal and a server for controlling the same.

### BACKGROUND ART

Clothes are essential for human life in a modern society. Clothes protect a body from the outside, and help the body temperature to be uniformly maintained. Clothes perform a practical function of hiding and protecting a body.

Further, clothes have various colors due to the development of dyeing technology, and have various designs due to the development of fiber processing technology and the like, so that the clothes also become a means of self-expression.

Various entertainers in the entertainment industry wear various clothes expressing their own personality which advantageously helps promote their unique signature style. For example, at a concert of a singer, several tens of thousands of members of the audience fascinated by a star quality of the singer gather. In the past, fan clubs of singers represent that members of the fan clubs are fans of corresponding singers through various colors of balloons for each singer.

Further, in the sport industry, a team member wears a team uniform to discriminate between teams during a sport game, and further, the team uniform is sold to fans to strengthen a sense of fellowship between the team and the fans. In this case, the fans wear uniforms of their favorite players, so that the fans may cheer for their favorite players and feel a sense of fellowship with the corresponding players. A cheering party of the team sets clothes with a uniform of a team.

In the foregoing situation, the audience seeing the concert of the singer may have a desire to express that he/she is a fan of the corresponding singer, and may have a desire to communicate with his/her favorite singer by expressing himself/herself to the corresponding signer.

Further, in the sport industry, the cheering party of the team may wear the uniform of the team and cheer for the team, such as in a card section, doing waves, and a cheering song, performed by the cheering party as the “crowd”. However, the card section and the like have a large cheering effect, but there may be a problem in that the crowd needs to gather and do a practice in advance.

Accordingly, the audiences may have demands for means for expressing themselves within the crowd. Further, the crowd may have demands for means by which the audiences are unified into one as a crowd to send cheering support to their favorite singers or sport teams in a unit of a fan club, a cheering party, and the like.

Further, interest in a wearable device is increased, so that a technology related to smart clothes is also developed. However, currently released smart clothes put weight on functionality. Accordingly, there may be demands for smart clothes which can express a unique individuality of a person or a group.

Korean Utility Model No. 20-0294324 discloses clothes with a billboard attached.

### DISCLOSURE

### Technical Problem

The present disclosure is conceived in response to the foregoing background art, and an object of the present disclosure is to provide clothes for a wearer to express himself/herself in a crowd.

Another object of the present disclosure is to provide clothes with which a crowd is capable of representing their allegiance.

Another object of the present disclosure is to provide clothes with which audiences are unified into one as a crowd to perform cheering and the like without advance practice.

Another object of the present disclosure is to provide clothes with which a person or a group may express unique individuality.

Another object of the present disclosure is to provide clothes which serve as an appealing point for a next generation wearable fashion.

### Technical Solution

According to an exemplary embodiment of the present disclosure for achieving the foregoing objects, clothes for providing a display function are provided. The clothes may include: a flexible display module including a predetermined number of light emitting diode elements disposed at a predetermined interval; a communication module which communicates with at least one of a user terminal and a control server, and receives at least one of a control signal and image data, the image data including at least one of still image data and video data; a control module which controls the flexible display module to output an image corresponding to the received image data in response to the received control signal or a control signal generated by the control module; and a memory module which stores at least one of an image that is displayable in the flexible display module and identification information of the clothes.

Further, according to an exemplary embodiment of the present disclosure, a user terminal for controlling clothes providing a display function is disclosed. The user terminal may include: a display module which displays information for controlling the clothes providing the display function; a user input module which receives an input of a user for controlling the clothes providing the display function; a control module which generates at least one of a signal for controlling the clothes providing the display function and image data to be displayed in a display of the clothes at least partially based on an input signal of the user the image data including at least one of still image data and video data; and a communication module which transmits at least one of the signal for controlling the clothes providing the display function and the image data to be displayed on a display of the clothes to the clothes providing the display function.

Furthermore, according to an exemplary embodiment of the present disclosure, a control server for controlling clothes providing a display function is disclosed. The control server may include: an identification information obtaining module which obtains at least one of identification information of the clothes providing the display function and identification information of a user terminal; a control module which generates at least one of a signal for controlling the clothes for providing the display function and image data to be displayed on the display of the clothes at least partially based on at least one of the identification information of the clothes for providing the display function and the identification information of the user terminal, the image data including at least one of still image data and video data; and a communication module which transmits at least one of the signal for controlling the clothes providing the display function and the image data to be displayed on a display of the clothes to at least one of the clothes providing the display function and the user terminal.

### Advantageous Effects

The present disclosure may provide clothes for a wearer to express himself/herself in a crowd.

The present disclosure may provide clothes with which a crowd is capable of representing their allegiance.

The present disclosure may provide clothes with which audiences are unified into one as a crowd to perform cheering and the like without an advance practice.

The present disclosure provides clothes with which a person or a group may express unique individuality.

The present disclosure may provide clothes which serve as an appealing point for a next generation wearable fashion.

### DESCRIPTION OF DRAWINGS

FIG. 1 is a block diagram of clothes providing a display function related to an exemplary embodiment of the present disclosure.

FIG. 2 is a diagram illustrating an example of the clothes providing the display function related to the exemplary embodiment of the present disclosure.

FIG. 3 is a block diagram of a user terminal for controlling the clothes providing the display function related to the exemplary embodiment of the present disclosure.

FIG. 4 is a block diagram of a control server for controlling the clothes providing the display function related to the exemplary embodiment of the present disclosure.

FIG. 5A is a diagram illustrating an example in which a user terminal controls clothes providing a display function related to a first exemplary embodiment of the present disclosure.

FIG. 5B is a diagram illustrating an example in which a user terminal controls clothes providing a display function related to a second exemplary embodiment of the present disclosure.

FIG. 6 is a concept diagram of a network including the control server, the user terminal, and the clothes providing the display function related to the exemplary embodiment of the present disclosure.

FIG. 7A is a diagram illustrating an example in which a control server or a user terminal controls clothes providing a display function related to a third exemplary embodiment of the present disclosure.

FIG. 7B is a diagram illustrating an example in which a control server or a user terminal controls clothes providing a display function related to a fourth exemplary embodiment of the present disclosure.

### BEST MODE

Various exemplary embodiments will be described with reference to the accompanying drawings, and like reference numerals are used for designating like constituent elements throughout the drawings. In the present specification, various descriptions are suggested for helping to understand the present disclosure. However, it is apparent that the exemplary embodiments may be carried out without a particular description. In other examples, publicly-known structures and devices are provided in a form of a block diagram in order to easily describe the exemplary embodiments.

Terms “component”, “module”, “system”, and the like used in the present specification refer to a computer-related entity, hardware, firmware, software, a combination of software and hardware, or execution of software. For example, the component may be a processing process, a processor, an object, an execution thread, a program, and/or a computer executed in a processor, but is not limited thereto. For example, all of an application executed in a computing device and the computing device may be components. One or more components may reside within a processor and/or an execution thread, and one component may be localized within one computer, or distributed between two or more computers. Further, the components may be executed by various computer readable media having various data structures stored in the media. The components may communicate through local and/or remote processing according to, for example, a signal (for example, data from one component interworking with another component in a local system and a distribution system and/or data through a network, such as the Internet, with another system through a signal) including one or more data packets.

Descriptions of the suggested exemplary embodiments are provided so that those skilled in the art may use or carry out the present disclosure. Various modifications of the exemplary embodiments may be apparent to those skilled in the art, and general principles defined herein may be applied to other exemplary embodiments without departing from the scope of the present disclosure. Accordingly, the present disclosure is not limited to the exemplary embodiments suggested herein, and shall be interpreted within the broadest meaning range consistent to the principles and new characteristics suggested herein.

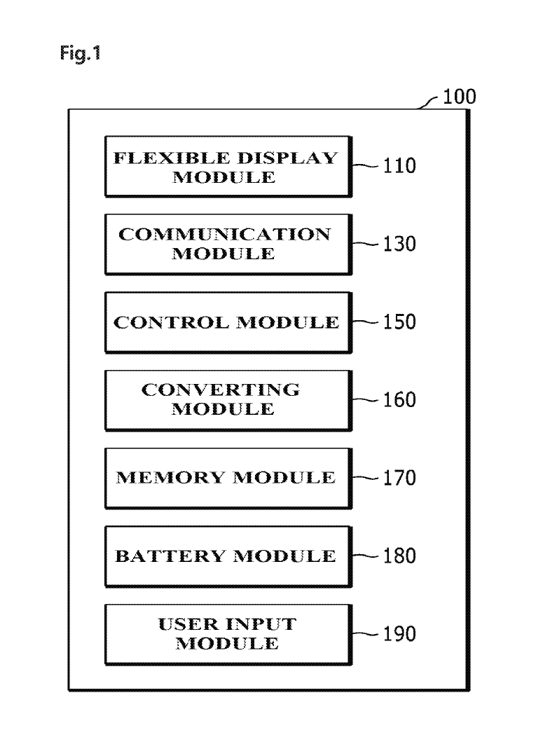

FIG. 1 is a block diagram of clothes providing a display function related to an exemplary embodiment of the present disclosure.

The clothes providing the display function related to the exemplary embodiment of the present disclosure may include a flexible display module 110, a communication module 130, a control module 150, a converting module 160, and a memory module 170.

The flexible display module 110 may be formed of the predetermined number of light emitting diode elements which are disposed at a predetermined interval. The light emitting diode elements may include various elements, such as an LED. Further, the flexible display module 110 may also include an LCD. The flexible display module 110 is flexible, and may include waterproof coating providing a waterproof function for blocking moisture introduced from the outside of the flexible display module 110. The waterproof coating may be coating with a special flexible urethane film. The foregoing material of the waterproof coating is simply an example, and the waterproof coating with various materials which are flexible and are capable of performing a waterproof function may be formed on the flexible display module 110. The flexible display module 110 may include LED elements which are capable of expressing the three primary colors (RGB) of light. The LED elements may be disposed at a predetermined interval to make the display module 110 be flexible. Further, the flexible display module 110 may be formed of a transparent material with which the flexible display module 110 is not viewed from the outside when a power supply is turned off. The flexible display module 110 may be positioned in a portion of a chest of a front surface of a user when the user wears the clothes. Further, the flexible display module 110 may be positioned on an external surface or an internal surface of the clothes. When the flexible display module 110 is positioned in the internal surface of the clothes, a fabric for preventing the flexible display module 110 from being in direct contact with a body of the wearer of the clothes may be added between the flexible display module 110 and the body of the wearer.

The flexible display module 110 may display an image stored in the memory module 170. The image stored in the memory module 170 may be an image which is appropriately converted to be displayed on the flexible display module 110.

The flexible display module 110 may display an image corresponding to an image displayed in the user terminal. The image may include a picture and a video. For example, the flexible display module 110 may display the same image as an image displayed in the user terminal. Further, the flexible display module 110 may also display a music video of a corresponding singer when a sound source of a specific singer is reproduced in the user terminal. The foregoing image displayed in the flexible display module 110 is simply an example, and the flexible display module 110 may display various images corresponding to the image displayed in the user terminal.

The flexible display module 110 may receive at least one of a control signal of the flexible display module and image data from at least one of the user terminal 200 and the control server 300, and output an image related to an image output in other clothes providing a display function positioned within a predetermined distance. The image related to the image output in other clothes may include at least one of an image corresponding to an image output in other clothes and an image which is combinable with the image output in other clothes. Further, the image which is combinable with the image output in other clothes may be based on relative positions of the clothes. The flexible display module 110 may receive at least one of a control signal of the flexible display module and image data from at least one of the user terminal 200 and the control server 300, output an image related to an image output in other clothes positioned within a predetermined distance (for example, adjacent), and output an image so that the images output in the plurality of clothes are combined to be output as one image. For example, when audiences in a concert hall wear the clothes 100 providing the display function, the flexible display module 110 may output an image so that images output in the clothes 100 and 101 worn by the audiences of the concert hall become a picture of a specific singer. To this end, the distance within the predetermined distance may be a distance including adjacent seats in the concert hall. The foregoing image output on the flexible display module 110 is simply an example, and the flexible display module 110 may output various images which are combinable with the image output by another flexible display module 110 positioned within the predetermined distance.

The communication module 130 may communicate with at least one of the user terminal 200 and the control server 300 and receive at least one of a control signal and image data. The image data may include at least one of the image and video data. The communication module 130 may receive the control signal for controlling the clothes 100 and image data that may be output on the flexible display module 110 from at least one of the user terminal 200 and the control server 300. Further, the communication module 130 may also communicate with other clothes 101 providing a display function to exchange information. The communication module 130 may also communicate with other clothes 101 providing a display function and receive an image which is combinable with an image output by another flexible display module positioned within the predetermined distance.

The communication module 130 may include at least one of a Bluetooth module, an infrared communication module, a WiFi module, and a communication module that may receive a signal of a predetermined frequency band. At least one of the control server 300 and the user terminal 200 may transmit a signal of a predetermined first frequency band to a first group and transmit a signal of a predetermined second frequency band to a second group so as to output a different image for each group of the clothes providing the display function. The communication module 130 may selectively receive image data from at least one of the user terminal 200 and the control server 300, and may make the images displayed in the plurality of clothes be combined or a different image be displayed for each group of the plurality of clothes. The foregoing communication module 130 is simply an example, and may include all kinds of communication modules that are communicable with the user terminal 200 and the control server 300.

The control module 150 may control the flexible display module 110 to output an image corresponding to the received image data in response to the received control signal or a control signal generated by the control module.

The control module 150 may include the converting module 160 which converts the received image data so that the flexible display module 110 may output the received image data. The flexible display module 110 may have limited expressible resolution compared to that of the user terminal 200, so that the converting module 160 may convert the image data to have appropriate resolution outputtable by the flexible display module 110. The converting module 160 may convert the image data received from at least one of the user terminal 200 and the control server 300 to be appropriate to be output on the flexible display module 110. The converting module 160 may include a separate codec or a publicly known codec for the conversion.

The control module 150 may control the flexible display module 110 to output an image corresponding to the image displayed in the user terminal 200 as described above. Further, the control module 150 may control the flexible display module 110 to output an image related to an image output in other clothes providing a display function positioned within the predetermined distance. As described above, the image related to the image output in other clothes may include at least one of an image corresponding to an image output in other clothes and an image which is combinable with the image output in other clothes. Further, the image which is combinable with the image output in other clothes may be based on relative positions of the clothes.

The memory module 170 may store an image outputtable by the flexible display module 110, identification information of the clothes 100 providing the display function, identification information of the user terminal 200 related to the clothes 100, information related to the control server 300, and the like. The foregoing information storable in the memory module 170 is simply an example, and the memory module 170 may store information based on which the clothes 100 providing the display function is operated according to the exemplary embodiment of the present disclosure.

The memory module 170 may include at least one type of storage medium among a flash memory type, a hard disk type, a multimedia card micro type, and a card type memory (for example, an SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk.

The battery module 180 may supply power to the clothes 100 providing the display function. The battery module 180 may include a lithium (Li) ion battery. The foregoing kind of battery is simply an example, and the battery module 180 may include the appropriate kinds of batteries for providing a power source to the clothes 100 providing the display function according to the exemplary embodiment of the present disclosure. The battery module 180 may include a charging cable connection module for wire charging. Further, the battery module 180 may include a wireless charging module for wireless charging.

The user input module 190 may receive a control signal of the clothes 100 providing the display function from the user. The user input module 190 may receive a control signal of the flexible display module 110. The user input module 190 may include a key pad, a dome switch, a touch pad (capacitive/resistive), a jog wheel, a jog switch, a camera, a voice recognizing module, and the like.

Although not illustrated, the clothes 100 may further include a voice output module. The voice output module may output a voice signal corresponding to image data. The voice output module may also be included in the clothes 100, and may also be separately present from the clothes 100 by using a near field wireless communication technology.

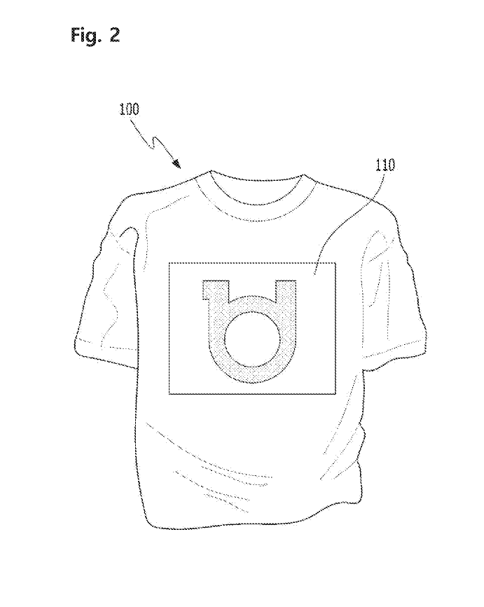

FIG. 2 is a diagram illustrating an example of the clothes providing the display function related to the exemplary embodiment of the present disclosure.

As illustrated in FIG. 2, the clothes 100 providing the display function related to the exemplary embodiment of the present disclosure may be formed in a shape of a T-shirt. However, the illustration of FIG. 2 is simply an example, and the clothes 100 providing the display function related to the exemplary embodiment of the present disclosure may be formed in a shape of predetermined clothes (for example, a hat and pants).

In FIG. 2, the clothes 100 providing the display function formed in a shape of a T-shirt are described for convenience of description.

The clothes 100 providing the display function may include the flexible display module 110 which is disposed to be positioned on a front surface of a user when the user wears the clothes 100.

Although not illustrated in FIG. 2, the communication module 130, the control module 150, the converting module 160, the memory module 170, the battery module 180, and the user input module 190 may be positioned at a predetermined position at which the modules may be connected with the flexible display module 110 in the clothes 100. For example, the modules may be wisely or wirelessly connected with the flexible display module 110 and positioned on a left surface of the clothes. Further, the modules may be wirelessly connected with the flexible display module 110 and positioned on a right surface of the clothes. Further, the modules may also be disposed on a rear surface of the flexible display module 110. The foregoing dispositions of the modules are simply examples, and the modules may be disposed at various positions at which the modules may be connected with the flexible display module 110 in the clothes 100.

The flexible display module 110 may be disposed on an external surface or an internal surface of the clothes 100 as described above.

The contents described with reference to FIG. 2 and the description of the foregoing appearance of the clothes 100 providing the display function are simply the examples presented for the description, and the clothes 100 providing the display function according to the present disclosure is not limited by the appearance illustrated in FIG. 2.

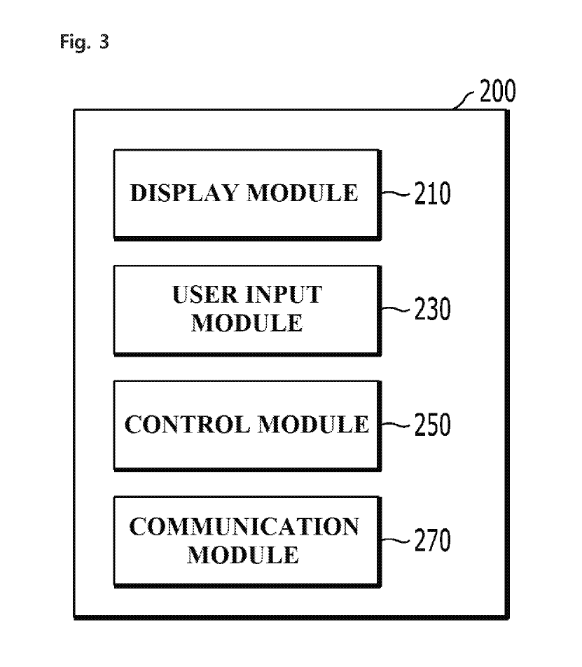

FIG. 3 is a block diagram of the user terminal for controlling the clothes providing the display function related to the exemplary embodiment of the present disclosure.

The user terminal 200 for controlling the clothes providing the display function related to the exemplary embodiment of the present disclosure may include a display module 210, a user input module 230, a control module 250, and a communication module 270.

The display module 210 may display information for controlling the clothes 100 providing the display function. The information for controlling the clothes 100 providing the display function may include information for turning on/off the display module 110 of the clothes 100, information for selecting an image to be displayed in the clothes 100, mapping information of identification information of the clothes 100 and identification information of the user terminal 200, relative position information of the clothes 100 and 101, grouping information of the clothes 100 and 101, and the like. The foregoing information for controlling the clothes 100 providing the display function is simply an example, and according to various exemplary embodiments of the present disclosure, the information may include predetermined information for controlling the clothes 100.

The display module 210 may display a user interface (UI) of a social networks service through which the users of the clothes 100 providing the display function may communicate. The SNS may be provided by a separate web server (not illustrated). In the SNS, the users of the clothes 100 may share contents to be displayed in the clothes.

In addition, the display module 210 may include at least one of a liquid crystal display (LCD), a light emitting diode display (LED display), a thin film transistor liquid crystal display (TFT LCD), an organic light emitting diode ((SLED), a flexible display, and a 3D display. Among them, some displays may be formed in a transparent type or a light transmissive type, which can viewed from the outside. This may be called a transparent display, and a representative example of the transparent display is a transparent OLED (TOLED).

Further, the display module 210 may include a touch screen.

The user input module 230 may receive an input of the user for controlling the clothes 100 providing the display function. The user input unit 230 may include a key pad, a dome switch, a touch pad, a jog wheel, a jog switch, and the like. Further, the user input module 230 may include a touch screen, a microphone, a camera, and the like. The user may make an input for controlling the clothes 100 through the user input module 230. The user may turn on/off the clothes 100, select an image output in the clothes 100, input the identification information of the clothes 100, map the identification information of the clothes 100 and the identification information of the terminal, input the relative position information of the clothes 100 and 101, and information for grouping the clothes 100 and 101 through h user input module 230. The foregoing user inputs are simply examples, and according to various exemplary embodiments of the present disclosure, the user input module 230 may receive all of the inputs of the user for controlling the clothes 100.

The user input module 230 may receive an input Which customizes contents to he displayed in the clothes 100 providing the display function. The user may change the contents to be displayed in the clothes 100 as he/she wants or design the contents in his/her own style through the user input module 230. For example, when the content to be displayed in the clothes 100 providing the display function is an album jacket picture of a singer, and the user receives an autograph from the singer, the autograph of the singer may be input to the corresponding content and the content may be displayed. The foregoing description is simply an example, and the user may perform predetermined customization on a predetermined content through the user input module 230.

The control module 250 may generate a signal for controlling the clothes 100 providing the display function and image data to be displayed on the display 110 of the clothes 100 at least partially based on an input signal of the user. The image data may include at least one of image data and video data. For example, the control module 250 may generate a control signal for turning on/off the clothes 100. Further, the control module 250 may generate image (for example, a picture of a singer) data to be displayed in the clothes 100. The foregoing control signal is simply an example, and the control module 250 may generate all kinds of signals for controlling the clothes 100 as described above. Further, the foregoing image data is simply an example, and the control module 250 may generate all kinds of image data to be displayed in the clothes 100 as described above.

Further, although not illustrated, the control module 250 may include a converting module which converts image data into image data which may he output in the clothes 100. The display module 110 of the clothes 100 may have limited expressible resolution compared to that of the user terminal 200, so that the converting module may convert the image data to have appropriate resolution outputtable by the clothes 100. The user terminal 200 may transmit the converted image data to the clothes 100.

The control module 250 may receive content purchase authentication information from the user, and when the user is authenticated as the user purchasing the content, the control module 250 may generate image data to be displayed in the clothes 100 corresponding to the content. For example, when the control module 250 receives information on a purchase authentication of an album of a singer from the user and the user is authenticated as the user purchasing the album of the singer, the control module 250 may generate jacket picture data of the album so as to display the jacket picture of the album of the singer in the clothes 100. Further, the image to be displayed in the clothes 100 generated by the control module 250 may also include an image of a music video of the singer, a producing behind story image of the album of the singer, and the like. Accordingly, the purchaser of the album of the singer may express that he/she is a fan of the corresponding singer through an image and the like which other people cannot possess. The foregoing content and image data are simply examples, and when purchases of the corresponding contents are authenticated for various contents, the control module 250 may provide various image data.

The control module 250 may generate image data to be displayed on the displays of the plurality of clothes 100 and 101 providing the display function at least partially based on at least one of the identification information of the clothes 100 providing the display function and the identification information of other user terminal 201. The image data may be combined with the images output in the clothes positioned within the predetermined distance at least partially based on the relative positions of the plurality of clothes. The image data may be image data by which the images output by the plurality of clothes positioned with the plurality of predetermined distances are combined to become one image. For example, the control module 250 may generate image data, by which the images output in the clothes 100 and 101 positioned within the predetermined distance that is a distance including an adjacent seat in a concert hall are combined with each other to become one picture of a singer. The foregoing image data is simply an example, and the control module 250 may generate image data so that the clothes 100 and 101 are mutually related to each other to output images.

The control module 250 may recognize the relative positions of the clothes 100 and 101 at least partially based on the identification information of the clothes 100 providing the display function. Further, the control module 250 may recognize the positions of the clothes 100 and 101 controlled by the other user terminal 101 based on identification information of the other user terminal 101. For example, in the concert hall, the control module 250 may receive identification information of the clothes 100 and 101, receive seat disposition information of the concert hall, and receive the identification information of the clothes 100 and 101. For example, when the users reserve tickets of the concert, the users may input identification information of the clothes and a seat number. The user terminal 200 may obtain the identification information of the clothes 100 and 101, which are positioned in the seats, respectively, based on the information. The control module 250 may generate image data outputtable in the clothes 100 and 101, which are positioned in the seats, respectively, based on the information. The foregoing recognition of the relative positions of the clothes is simply an example, and the user terminal 100 may recognize the relative positions of the clothes by various methods. The control module 250 may generate image data, by which the clothes 100 and 101 output the mutually related images, by various methods.

The control module 250 may group at least one of the plurality of clothes 100 and 101 and the plurality of user terminals 200 and 201, and generate image data to be displayed on the displays of the plurality of clothes 100 and 101 providing the displays at least partially based on at least one of the identification information of the clothes 100 providing the display function and the identification information of the plurality of user terminals 200. The image data may be output in the grouped clothes for each group. The control module 250 may group the clothes 100 and 101 and generate image data, by which an image is output for each group. For example, in a concert hall in which the plurality of singers appears, the control module 250 may generate image data, by which a picture of a first singer is output on the clothes of fans of the first singer at least partially based on identification information of the clothes 100 and 101 of the fans of the first singer and the user terminals 200 and 201. Further, for example, in a concert hall in which the plurality of singers appears, the control module 250 may generate image data, by which the clothes 100 and 101 positioned at designated seats of the fans of a second singer output a picture of the second singer at least partially based on information about the designated seats of the fans of the second singer. The foregoing image data, by which the picture of the singer is output, may include image data, by which the picture of the singer is output for each clothes 100, or image data, by which the pictures output by the clothes 100 and 100 of fans of a specific singer are combined so that a picture of the singer is output. The foregoing image data is simply an example, and the control module 250 may generate various image data outputtable by the grouped clothes 100 and 101.

Further, the control module 250 may generate image data, by which an image related to a first singer is output in the clothes worn by fans of the first singer, and an image related to a second singer is output in the clothes worn by fans of the second singer, for example, at least partially based on the identification information of the user terminal 200 controlling the clothes worn by the fans of the first singer and the user terminal 201 controlling the clothes worn by the fans of the second singer. The foregoing image data is simply an example, and the control module 250 may generate various image data transmittable to the grouped user terminals.

The communication module 270 may transmit at least one of the image data to he displayed on the displays of the plurality of clothes 100 and 101 and signals for controlling the plurality of clothes 100 and 101 to at least one of the plurality of clothes 100 and 101 and the other user terminal 201 which may control the plurality of clothes based on at least one of the identification information of the plurality of clothes and the identification information of the other user terminal. The user terminal 200 may control the clothes 100 connected with the user terminal 200, and the other user terminal 201 may control other clothes 101 connected with the other user terminal 201. Further, the user terminal 200 may directly communicate with other clothes 101 to control the other clothes 101, and may communicate with the other user terminal 201 connected with the other clothes 101 for controlling the other clothes 101. The communication module 270 may transmit the image data to be displayed in the clothes 100 and 101 and the signals for controlling the clothes 100 and 101 to the clothes 100 and 101, or the other user terminal 201 which may control the clothes.

The communication module 270 may transceive at least one of the signal for controlling the clothes providing the display function and image data with at least one of the control server 300, the other user terminal 201, and the clothes 100 providing the display function. The communication module 270 may receive at least one of the signal for controlling the clothes 100 and the image data from the control server 300, and transmit the received signal and/or image data to the clothes 100 or the other user terminal 201. The communication module 270 may include a wired/wireless communication module for the transception. Further, the communication module 270 may include a short range communication module, and may communicate with at least one of the clothes 100 and the other user terminal 201. The communication module 270 may include at least one of a Bluetooth module, an infrared communication module, a WiFi module, and a communication module that may transceive a signal of a predetermined frequency band. In order to output a different image for each group of the clothes providing the display function, the communication module 270 may transmit a signal of a predetermined first frequency band to a first group and transmit a signal of a predetermined second frequency band to a second group.

The communication module 270 may access a temporary address of the control server set by the control server 300 and establish a communication channel with the control server 300, and may transceive at least one of the image data and the control signal of the clothes with the control server 300 through the communication channel. The control server 300 may generate one or more temporary addresses. The communication module 270 may access the temporary address generated by the control server 300 and establish the communication channel with the control server 300. The communication module 270 may transceive at least one of the image data to be displayed in the clothes and the control signal with the control sever through the communication channel.

Further, although not illustrated, the user terminal 200 may include a memory module. The memory module may store the identification information of the clothes providing the display function, information about the control server, the image data to be displayed in the clothes providing the display function, and the like.

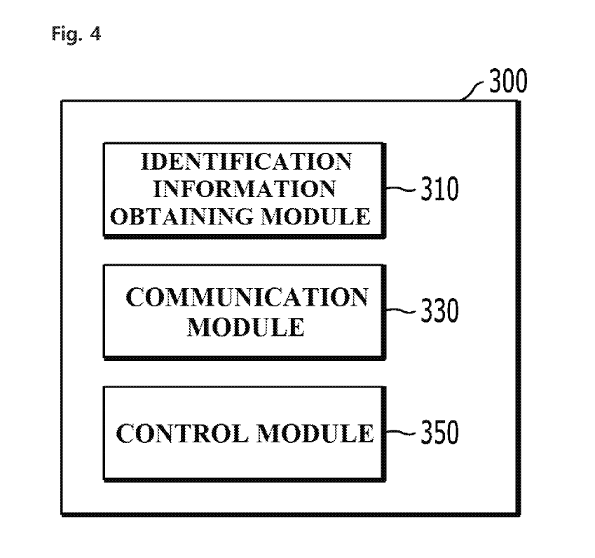

FIG. 4 is a block diagram of the control server for controlling the clothes providing the display function related to the exemplary embodiment of the present disclosure.

The control server may include an identification information obtaining module 310, a communication module 330, and a control module 350.

The identification information obtaining module 310 may obtain at least one of the identification information of the clothes 100 and 101 providing the display function and the identification information of the user terminals 200 and 201. For example, in a case of a concert of a singer, when the user reserves a ticket of the concert, the identification information obtaining module 310 may obtain the identification information of the clothes 100 or the user terminal 200 at least partially based on the identification information of the clothes 100 or the identification information (for example, a telephone number and a terminal identification number) of the user terminal input by the user. The identification information obtaining module 310 may recognize dispositions of the clothes 100 and the user terminal 200 in a concert hall at least partially based on the foregoing information and concert seat disposition information. For example, the control server 300 may recognize that a fan of a first singer is positioned in seat H and a fan of a second singer is positioned in seat D in the concert at least partially based on the information obtained by the identification information obtaining module 310. The foregoing identification information is simply an example, and the identification information obtaining module 310 may obtain various identification information of the clothes 100 and the user terminal 200 by various methods.

The communication module 330 may transmit at least one of the signal for controlling the clothes 100 providing the display function and the image data to be displayed on the display of the clothes 100 to at least one of the clothes 100 providing the display function and the user terminal 200. The communication module 330 may transmit at least one of the image data to be displayed on the displays of the plurality of clothes 100 and 101 and signals for controlling the plurality of clothes 100 and 101 to at least one of the plurality of clothes 100 and 101 and the user terminals 200 and 201 which may control the plurality of clothes based on at least one of the identification information of the plurality of clothes and the identification information of the user terminals 100 and 101. The communication module 330 may directly transmit the control signal and the image data to the plurality of clothes 100 and 101, or may transmit the control signal and the image data to the user terminals 200 and 201 communicable with the plurality of clothes 100 and 101 and transmit the control signal and the image data to the plurality of clothes 100 and 101. The communication module 330 may include a wired/wireless communication module for the transception. Further, in order to output a different image for each group of the clothes providing the display function, the communication module 330 may transmit a signal of a predetermined first frequency band to a first group and transmit a signal of a predetermined second frequency band to a second group.

The communication module 330 may transmit at least one of the image data to be displayed on the displays of the plurality of clothes 100 and 101 and the signals for controlling the plurality of clothes 100 and 101 to at least one of the plurality of clothes and the user terminals which may control the plurality of clothes based on at least one of the identification information of the plurality of clothes 100 and 101 and the identification information of the plurality of user terminals 200 and 201.

The communication module 330 may generate a temporary address which the plurality of grouped clothes 100 and the plurality of user terminals 200 may access for each group, and may transceive at least one of the image data and the control signal of the clothes to the plurality of clothes 100 and the plurality of user terminals 200 accessing the temporary address for each group. The user terminal 200 may be grouped. An example of the grouping is the same as that described above. In order to control the user terminal 200 for each group, the control server 300 may generate the temporary address which the user terminal 200 may access for each group. The communication module 330 may transceive at least one of the image data and the control signal of the clothes to the user terminal 200 accessing the temporary address. The temporary address may be divided for each group.

The control module 350 may generate at least one of a signal for controlling the clothes providing the display function and image data to be displayed on the display of the clothes at least partially based on at least one of the identification information of the clothes providing the display function and the identification information of the user terminal. The image data may include at least one of image data and video data.

Further, the control module 350 may generate image data to be displayed on the displays of the plurality of clothes providing the display function at least partially based on at least one of the identification information of the clothes 100 and 101 providing the display function and the identification information of the plurality of user terminals 200 and 201. The image data may be combined with the images output in the clothes positioned within the predetermined distance at least partially based on the relative positions of the plurality of clothes 100 and 101. For example, the control module 350 may generate image data, by which the images output in the clothes 100 and 101 positioned within a distance including an adjacent seat in a concert hall are combined with each other to become a picture of a singer.

The control module 350 may group at least one of the plurality of clothes 100 and 101 and the plurality of user terminals 200 and 201, and generate image data to be displayed on the displays of the plurality of clothes 100 and 101 providing the display function at least partially based on at least one of the identification information of the clothes 100 and 101 providing the display function and the identification information of the plurality of user terminals 200 and 201. The image data may be output in the grouped clothes 100 for each group.

The control module 350 may group the clothes based on the identification information of the clothes 100 and 101. For example, the control module 350 may group the identification information of the clothes 100 and 101 into a group in which a wearer of the clothes is a fan of a first singer and a group in which a wearer of the clothes is a fan of a second singer based on the identification information of the clothes 100 and 101 in a concert hall. The control module 350 may generate image data by which the image is output in the grouped clothes for each group. The foregoing image data may be, for example, image data by which a picture of the first singer is output in the clothes of the group including the fans of the first singer and a picture of the second singer is output in the clothes of the group including the fans of the second singer. The foregoing image data may be transmitted to the clothes 100 and 101 from the communication module 330 to be output in the clothes 100 and 101.

The control module 350 may group the clothes 100 and 101 based on the identification information of the user terminals 200 and 201. For example, the control module 350 may group the identification information of the user terminals into a group in which a possessor of the user terminal is a fan of the first singer and a group in which a possessor of the user terminal is a fan of the second singer based on the identification information of the user terminals 200 and 201 which may be communicated with the clothes 100 and 101 in the concert hall. The control module 350 may generate image data by which the image is output in the grouped clothes for each group. The foregoing image data may be, for example, image data by which a picture of the first singer is output in the clothes of the group including the fans of the first singer and a picture of the second singer is output in the clothes of the group including the fans of the second singer. The foregoing image data may be transmitted to the user terminals 200 and 201 from the communication module 330 to be output in the clothes 100 and 101 connected to the user terminals 200 and 201.

Further, although not illustrated, the control module 350 may include a converting module which converts image data into image data which may be output in the clothes 100. The display module 110 of the clothes 100 may have limited expressible resolution, so that the converting module may convert the image data to have appropriate resolution outputtable by the clothes 100. The control server 300 may transmit the converted image data to the clothes 100 and 101 and at least one of the user terminals 200 and 201.

Further, although not illustrated, the control server 300 may include a memory module. The memory module may store the identification information of the clothes providing the display function, the image data to be displayed in the clothes, the identification information of the user terminals related to the clothes, information by which the control server 300 is operated, and the like.

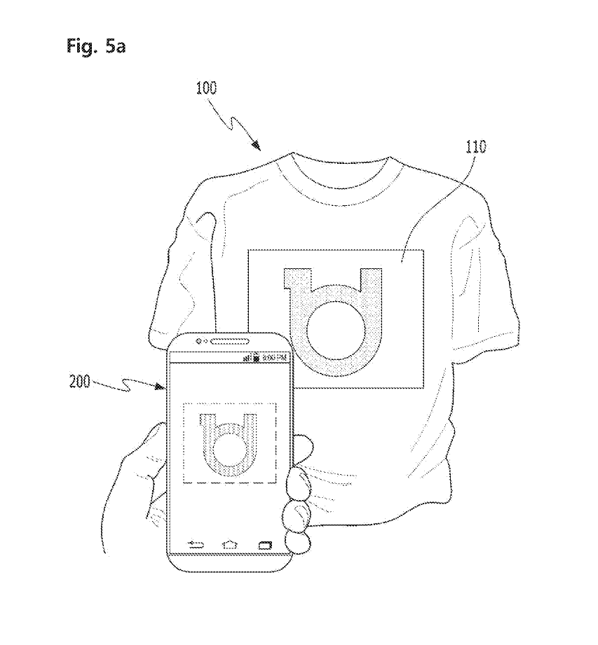

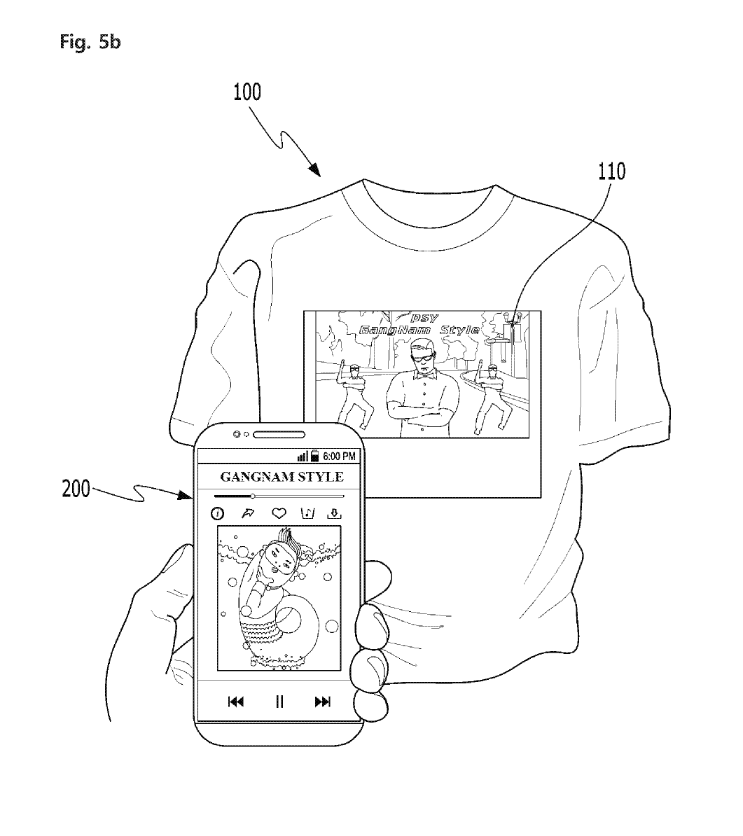

FIG. 5A is a diagram illustrating an example in which a user terminal controls clothes for providing a display function related to a first exemplary embodiment of the present disclosure.

In the first exemplary embodiment of the present disclosure, a user terminal 200 may control clothes 100 providing a display function. The user terminal 200 may make the clothes 100 providing the display function display an image corresponding to an image displayed in the user terminal 200. For example, the user terminal 200 may make the clothes 100 display the same image 110 as an image displayed in the user terminal 200. As described above, the display module 110 of the clothes 100 may have limited resolution compared to that of the user terminal 200, so that the image 110 may be an image, in which a size, resolution, and the like are converted so as to be output in the clothes 100. The image displayed in the user terminal 200 may be an image provided when the user performs a content purchase authentication as described above. Further, the user terminal 200 may also receive the image from the control server 300. The user terminal 200 may control the image displayed in the clothes 100. For example, the user terminal 200 may make an image included in a gallery of the user terminal 200 be displayed in the clothes 100. The foregoing images are simply examples, and the user terminal 200 may control the clothes 100 so that at least a part of the image output in the user terminal 200 is output in the clothes 100.

FIG. 5B is a diagram illustrating an example in which a user terminal controls clothes for providing a display function related to a second exemplary embodiment of the present disclosure.

In the second exemplary embodiment of the present disclosure, a user terminal 200 may control clothes 100 providing a display function. The user terminal 200 may make the clothes 100 providing the display function display an image corresponding to an image displayed in the user terminal 200. For example, when a specific sound source is reproduced in the user terminal, the user terminal 200 may make a music video 110 corresponding to the sound source be displayed in the clothes. For example, when a specific sound source is reproduced in the user terminal, the user terminal 200 may make a picture 110 of a singer of the sound source be displayed in the clothes 100. For example, the user terminal 200 may transmit content identification information to the clothes 100, and the clothes 100 identifies the contents based on the content identification information and display an image corresponding to the identified contents among the stored images. Further, the clothes 100 may confirm the contents by parsing a header part of the sound source and output corresponding output contents by parsing a header of the contents stored in the clothes 100. As described above, the display module 110 of the clothes 100 may have a limited resolution compared to that of the user terminal 200, so that the image 110 may be an image, in which a size, resolution, and the like are converted so as to be output in the clothes 100. As described above, the image 110 may be an image 110 provided when the user performs content purchase authentication and the user is authenticated as a user purchasing the contents. Further, the user terminal 200 may also receive the image 110 from the control server 300. The foregoing images are simply examples, and the user terminal 200 may control the clothes 100 so that an image corresponding to the image output in the user terminal 200 is output in the clothes 100.

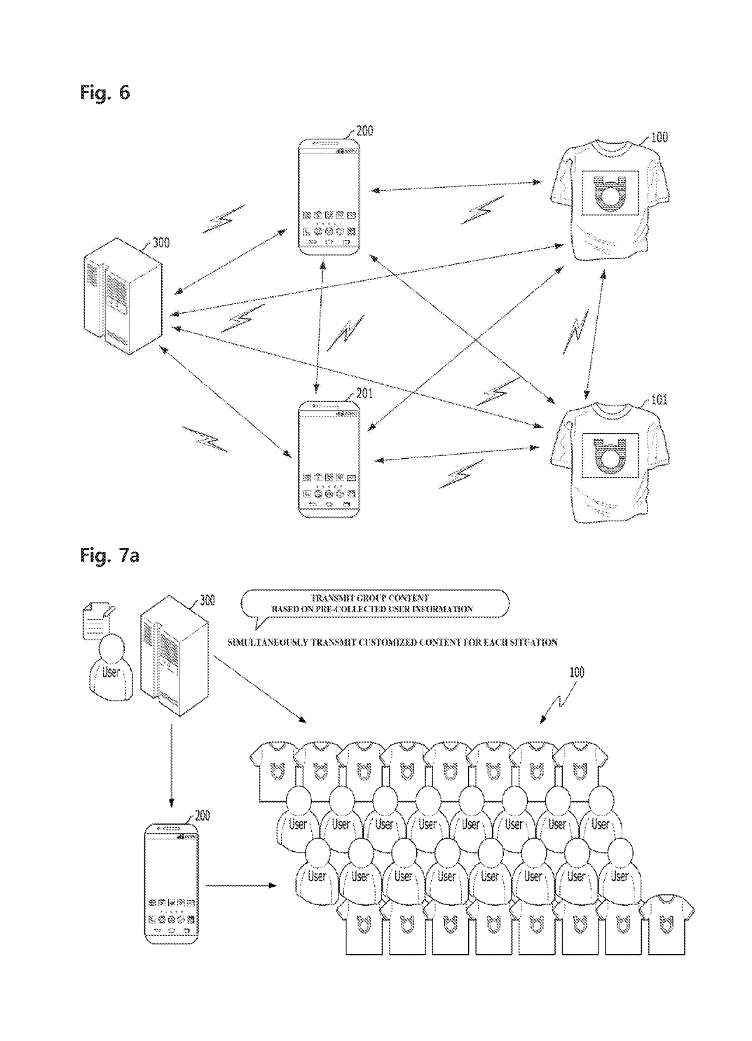

FIG. 6 is a concept diagram of a network including the control server, the user terminal, and the clothes providing the display function related to the exemplary embodiment of the present disclosure.

A network related to the exemplary embodiment of the present disclosure may include the control server 300, the user terminals 200 and 201, and the clothes 100 and 101 providing the display function. Each component of the network related to the exemplary embodiment of the present disclosure may communicate with other different components.

The control server 300 related to the exemplary embodiment of the present disclosure may communicate with the clothes 100 and 101 providing the display function. Further, the control server 300 may communicate with the user terminals 200 and 201 connected with the clothes 100 and 101 providing the display function to make the user terminals 200 and 201 control the clothes 100 and 101. Further, the user terminal 200 may communicate with the user terminal 201 to control the other clothes 101 connected with the other user terminal 201.

For example, in a concert hall, the control server 300 may control the clothes 100 and 101 worn by the entire audiences. The control server 300 may control the clothes 100 and 101 for each section of the audience seats based on the identification information of the clothes 100 and 101 in the concert hall. The control server 300 may control each of the clothes 100 and 101 to display a picture of a singer, both the clothes 100 and 101 to be combined to display a picture of a singer, each of the clothes 100 and 101 included in a group to display a picture of a singer for each specific group, or the clothes 100 and 101 to be combined based on each specific group to display a picture of a singer. The foregoing images displayed in the clothes 100 and 101 by controlling the clothes 100 and 101 by the control server 300 are simply examples, and the control server 300 may control the clothes 100 and 101 to display various images.

Further, for example, the control server 300 may make the user terminals 200 and 201 control the clothes 100 and 101 in the concert hall. The control server 300 may make the user terminals 200 and 201 control the clothes 100 and 101 for each section of the audience seats based on the identification information of the user terminals 200 and 201 in the concert hall. The control server 300 may control the user terminals 200 and 201 connected to the clothes, respectively, so that each of the clothes 100 and 101 displays a picture of a singer, may control the user terminals 200 and 201 connected to the clothes, respectively, so that both the clothes 100 and 101 are combined to display a picture of a singer, may control the user terminals 200 and 201 connected to the clothes, respectively, so that each of the clothes 100 and 101 included in the group displays a picture of a singer for each specific group, or may control the user terminals 200 and 201 connected to the clothes, respectively, so that the clothes 100 and 101 are combined based on each specific group to display a picture of a singer. Further, the user terminals 200 and 201 may also be connected to the clothes one to one, and one user terminal may also be connected with the plurality of clothes. The foregoing images displayed in the clothes 100 and 101 by controlling the clothes 100 and 101 by the control server 300 are simply examples, and the control server 300 may control the user terminals 200 and 201 connected to the clothes, respectively, so that the clothes 100 and 101 display various images.

The user terminal 200 may communicate with the control server 300. The user terminal 200 may receive image data to be displayed in the clothes 100 including the display function and a control signal of the clothes 100 from the control server 300. Further, the user terminal 200 may receive image data to be displayed in the clothes 100 including the display function and a control signal of the clothes 100 from the other user terminal 201. The user terminal 200 may communicate with the clothes 100. Further, the user terminal 200 may communicate with the other user terminal 201 connected with the clothes 100 to make the other user terminal 201 control the clothes 100.

For example, the user terminal 200 may control the clothes in the concert hall. Further, in a concert hall, the user terminal 200 may control the clothes 100 and 101 in the section of the audience in which the user of the user terminal 200 is positioned. The user terminal 200 may control the clothes 100 connected with the user terminal 200 to display a picture of a singer, may control each of the clothes 100 and 101 connected with the user terminal 200 to display a picture of a singer, and may control the images displayed in the clothes 100 and 101 connected with the user terminal 200 to be combined to display a picture of a singer. For example, the user terminal 200 of a president of a fan club may communicate with the user terminals 201 of vice presidents of the fan club in the concert hall. The user terminal 200 of the president of the fan club may make the user terminals 201 of the vice presidents of the fan club display a picture of a singer in each of the clothes 100 and 101 included in a group of the vice presidents of the fan club, or make the images displayed in the clothes included in each group be combined to display a picture of a singer. For example, the clothes included in a first vice president group may display a jacket picture of the first album of a corresponding singer and the clothes included in a second vice president group may display a jacket picture of the second album of the corresponding singer for each of the clothes, or may display images so that the images displayed in the corresponding group are combined to be become a jacket picture of a singer. The foregoing images displayed in the clothes 100 and 101 by controlling the clothes 100 and 101 by the user terminals 200 and 201 are simply examples, and the user terminals 200 and 201 may control the clothes 100 and 101 so as to display various images.

The clothes 100 providing the display function may communicate with at least one of the control server 300, the user terminal 200, and the other clothes 101. The clothes 100 providing the display function may receive image data from at least one of the control server 300 and the user terminal 200 and output the received image data through the display 110. Further, the clothes 100 providing the display function may control the other clothes 101. The clothes 100 and 101 providing the display function may be divided into master clothes and slave clothes, and the master clothes 100 may control the slave clothes 101. For example, the master clothes 100 may be the clothes worn by the president of the fan club in the concert hall. The slave clothes 101 may be the clothes worn by members of the fan club. The master clothes 100 may control each of the slave clothes 101 to output the picture of the singer. Further, the master clothes 100 may control an image to be output so that the images output in the slave clothes 101 are combined to become one picture of the singer. The images displayed by controlling the slave clothes 101 by the master clothes 100 are simply examples, and the master clothes 100 may control the slave clothes 101 so that the slave clothes 101 may display various images.

The control server 300 may generate the plurality of temporary addresses which the user terminals 200 may access. The temporary address may mean an address which the grouped user terminals 200 may access for each group. The control server 300 may transceive at least one of the control signal of the clothes and the image data with the user terminals 200 accessing the temporary address. The control server 300 may group the user terminals 200 through the temporary address and control the user terminals 200. For example, the control server 300 may generate the temporary addresses which the user terminals 200 of the group positioned in R seats and the user terminals 200 of the group positioned in S seats among the seats in the concert hall may access. The control server 300 may generate a first temporary address which the user terminals 200 positioned in the R seats may access and a second temporary address which the user terminals 200 positioned in the S seats may access. The user terminals 200 positioned in the R seats may access the first temporary address and receive the image data and the control signal of the clothes 100 from the control server 300. The user terminals 200 positioned in the S seats may access the second temporary address and receive the image data and the control signal of the clothes 100 from the control server 300.

Further, although not illustrated, the network related to the exemplary embodiment of the present disclosure may include an app server (not illustrated). The app server may provide an SNS platform through which the users of the clothes 100 providing the display function may communicate with one another. Further, the app server may provide an open market platform, in which a content to be displayed in the clothes providing the display function is provided to the user, or the content is uploaded from the user and is shared with another user. The open market platform may provide the user whose purchase of the content is authenticated with the content.

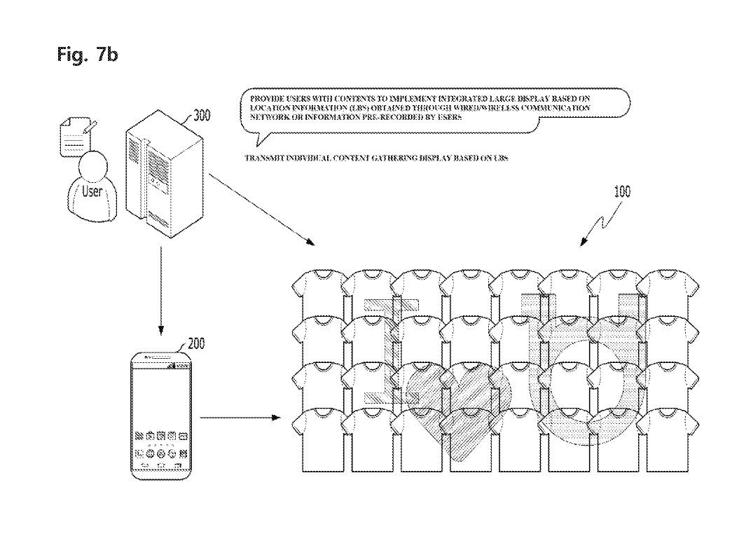

FIG. 7A is a diagram illustrating an example in which a control server or a user terminal controls clothes providing a display function related to a third exemplary embodiment of the present disclosure.

In the third exemplary embodiment of the present disclosure, a control server 300 may control the same image to be output in the clothes 100 providing a display function. Further, the control server 300 may control the user terminal 200 so as to control the clothes 100 providing the display function. For example, in a concert hall, the control server 300 may group the clothes based on identification information of the clothes. The control server 300 may control the clothes to output an image for each group based on identification information of the grouped clothes. The control server 300 may control different images to be output for each seat section in the concert hall. In a concert hall in Which the plurality of singers appears, the control server 300 may control a picture of a first singer to be output in the clothes positioned in a section in which a fan of the first singer may take a seat and a picture of a second singer to be Output in the clothes positioned in a section in which a fan of the second singer may take a seat at least partially based on a predetermined seating chart based on a fan of a singer. In the foregoing example, the clothes are grouped based on the fan of the singer, but the clothes may be grouped for each department of a company and for each team of a sport game, and the control server 300 may group the clothes by various methods.

FIG. 7B is a diagram illustrating an example in which a control server or a user terminal controls clothes providing a display function related to a fourth exemplary embodiment of the present disclosure.

In the fourth exemplary embodiment of the present disclosure, the control server 300 may control an image, which may be combined with images output in other clothes, to be output in the plurality of clothes providing the display function. Further, the control server 300 may control the user terminal 200 so as to control the clothes 100 providing the display function. For example, in a concert hall, the control server 300 may recognize relative positions of the clothes based on identification information of the clothes. Further, the control server 300 may recognize relative positions of the clothes based on identification information of a user terminal of a wearer of the clothes. The control server 300 may control each of the clothes to output an image so that images output in the respective clothes are combined to become a picture of a singer in a concert hall. Further, the control server 300 may control the user terminals 200 connected with each of the clothes so as to output the image so that images output in the respective clothes are combined to become the picture of the singer in the concert hall. Further, in a sport game and the like, the control server 300 may control each of the clothes or a user terminal connected to each of the clothes so that a card section is performed with an image output in each of the clothes when the seats of the audience are viewed. The foregoing description is simply an example, and the control server 300 may make the clothes output various images which are combinable with images output in adjacent clothes by controlling the plurality of user terminals 200 or the plurality of clothes 100.

Those skilled in the art may understand that information and signals may be expressed by using predetermined various and different technologies and schemes. For example, data, directions, commands, information, signals, bits, symbols, and chips, which may be referred in the foregoing description, may be expressed by voltages, currents, electromagnetic waves, magnetic fields or particles, optical fields or particles, or a predetermined combination thereof.

Those skilled in the art may understand that various exemplary logical blocks, modules, processors, means, circuits, and algorithm steps described in relation with the exemplary embodiments disclosed herein may be implemented by electronic hardware, various types of programs or design codes (for convenience, referred to as “software” herein), or a combination thereof. In order to clearly describe inter-compatibility of hardware and software, various exemplary components, blocks, modules, circuits, and steps have been generally described above in relation to the functions thereof. Whether the function is implemented as hardware or software depends on design limitations imposed to a specific application and the entire system. Those skilled in the art may implement the described functions with various methods for each specific application, but it shall not be construed that the determinations of the implementation depart from the scope of the present disclosure.

Various exemplary embodiments presented herein may be implemented as a manufactured article using a method, an apparatus, a standard programming, and/or an engineering technology. A term “manufactured article” includes a computer program, a carrier, or media accessible by a predetermined computer readable device. For example, the computer readable medium includes a magnetic storage device (for example, a hard disc, a floppy disc, and a magnetic strip), an optical disc (for example, a CD and a DVD), a smart card, and a flash memory device (for example, an EEPROM, a card, a stick, and a key drive), but is not limited thereto. Further, various storage media presented herein include one or more devices and/or another machine-readable medium for storing information. A term “machine-readable medium” includes a wireless channel and other various media capable of storing, possessing, and/or transporting a command(s) and/or data, but is not limited thereto.

It shall be understood that a specific sequence or a hierarchy structure of the steps included in the presented processes is an example of exemplary accesses. It shall be understood that based on a design priority, a specific sequence or a hierarchy structure of the steps included in the present processes may be re-arranged within the scope of the present disclosure. The accompanying method claims provide elements of various steps as a sample sequence, but do not mean the limitation to the presented specific sequence or hierarchy structure.

Descriptions of the presented exemplary embodiments are provided so that those skilled in the art may use or carry out the present disclosure. Various modifications of the exemplary embodiments may be apparent to those skilled in the art, and general principles defined herein may be applied to other exemplary embodiments without departing from the scope of the present disclosure. Accordingly, the present disclosure is not limited to the exemplary embodiments suggested herein, and shall be interpreted within the broadest meaning range consistent to the principles and new characteristics suggested herein.

### [Mode for Carrying Out the Invention]

From the foregoing, relevant contents have been described in the best mode for carrying out the invention.

### INDUSTRIAL APPLICABILITY

The present disclosure may be used in clothing, accessory, a bag, portable goods, and the like.

1. An article of clothing for providing a display function, the article of clothing comprising:
a flexible display including a predetermined number of light emitting diode elements disposed at a predetermined interval;
a processor configured to:
communicate with at least one of a user terminal and a control server,
receive at least one of a control signal and image data, the image data including at least one of still image data and video data, and
control the flexible display to output an image corresponding to the received image data in response to the received control signal or a control signal generated by the processor; and
memory configured to store at least one of an image that is displayable in the flexible display and identification information of the article of clothing.

2. The article of clothing of claim 1, wherein the flexible display displays an image corresponding to an image displayed in the user terminal.

3. The article of clothing of claim 1, wherein the flexible display receives at least one of a control signal of the flexible display and image data from at least one of the user terminal and the control server, and outputs an image related to an image output in other article of clothing for providing a display function positioned within a predetermined distance.

4. The article of clothing of claim 3, wherein the image related to the image output in the other article of clothing may include at least one of an image corresponding to the image output in the other article of clothing and an image which is combinable with the image output in the other article of clothing.

5. The article of clothing of claim 4, wherein the image which is combinable with the image output in the other article of clothing is based on relative positions of the article of clothing.

6. The article of clothing of claim 1, wherein the processor includes at least one of Bluetooth, infrared, WiFi, and a communicator which is capable of receiving a signal of a predetermined frequency band.

7. The article of clothing of claim 1, further comprising:
a user input interface configured to receive a control signal of the flexible display from a user; and
a battery configured to supply power to the article of clothing.

8. The article of clothing of claim 1, wherein the flexible display is flexible, and further includes a waterproof coating providing a waterproof function for preventing moisture introduced from the outside of the flexible display.

9. The article of clothing of claim 1, wherein the processor includes a converter configured to convert the received image data so that the received image data is output in the flexible display.

10. A user terminal for controlling an article of clothing providing a display function, the user terminal comprising:
a display configured to display information for controlling the article of clothing providing the display function;
a user input interface configured to receive an input of a user for controlling the article of clothing providing the display function; and
processor configured to:
generate at least one of a signal for controlling the article of clothing providing the display function and image data to be displayed in a display of the article of clothing at least partially based on an input signal of the user, the image data including at least one of still image data and video data, and
transmit at least one of the signal for controlling the article of clothing providing the display function and the image data to be displayed on the display of the article of clothing to the article of clothing providing the display function.

11. The user terminal of claim 10, wherein the processor is further configured to receive content purchase authentication information from the user, and when the user is authenticated as a user purchasing a content, the processor generates image data to be displayed on the display of the article of clothing corresponding to the content.

12. The user terminal of claim 10, wherein the processor is further configured to generate image data to be displayed on displays of a plurality of articles of clothing providing the display function at least partially based on at least one of identification information of the article of clothing providing the display function and identification information of another user terminal, and the image data is combinable with an image output in the article of clothing positioned within a predetermined distance at least partially based on relative positions of the plurality of articles of clothing.

13. The user terminal of claim 12, wherein the processor is further configured to transmit at least one of the image data to be displayed on the displays of the plurality of articles of clothing and signals for controlling the plurality of articles of clothing to at least one of the plurality of articles of clothing and the another user terminal that is capable of controlling the plurality of articles of clothing based on at least one of the identification information of the article of clothing and the identification information of the another user terminal.

14. The user terminal of claim 10, wherein the processor is configured to transceive at least one of the signal for controlling the article of clothing providing the display function and the image data with at least one of a control server, another user terminal, and the article of clothing providing the display function.

15. The user terminal of claim 10, wherein the processor is further configured to group at least one of the plurality of articles of clothing and a plurality of user terminals and generate image data to be displayed on displays of the plurality of articles of clothing providing the display function at least partially based on at least one of identification information of the plurality of articles of clothing providing the display function and identification information of the plurality of user terminals, and the image data is output in the grouped articles of clothing for each group.

16. The user terminal of claim 10, wherein the processor is further configured to access a temporary address of a control server set by the control server to establish a communication channel with the control server, and transceive at least one of the image data and the signal of the article of clothing with the control server through the communication channel.

17. A control server for configured to control an article of clothing providing a display function, the control server comprising:
a processor configured to:
obtain at least one of identification information of the article of clothing providing the display function and identification information of a user terminal;
generate at least one of a signal for controlling the article of clothing providing the display function and image data to be displayed on the display of the article of clothing at least partially based on at least one of the identification information of the article of clothing providing the display function and the identification information of the user terminal, the image data including at least one of still image data and video data; and
transmit at least one of the signal for controlling the article of clothing providing the display function and the image data to be displayed on a display of the article of clothing to at least one of the article of clothing providing the display function and the user terminal.

18. The control server of claim 17, wherein the processor is further configured to generate image data to be displayed on displays of a plurality of articles of clothing providing the display function at least partially based on at least one of identification information of the plurality of articles of clothing providing the display function and identification information of a plurality of user terminals, and
the image data being combinable with the images output in the article of clothing positioned within a predetermined distance at least partially based on relative positions of the plurality of articles of clothing.

19. The control server of claim 18, wherein the processor is further configured to transmit at least one of the image data to be displayed on the displays of the plurality of articles of clothing and signals for controlling the plurality of articles of clothing to at least one of the plurality of articles of clothing and the user terminal which is capable of controlling the plurality of articles of clothing based on at least one of the identification information of the plurality of articles of clothing and the identification information of the plurality of user terminals.

20. The control server of claim 17, wherein the processor groups at least one of the plurality of articles of clothing and the plurality of user terminals and generates image data to be displayed on displays of the plurality of articles of clothing providing the display function at least partially based on at least one of the identification information of the plurality of articles of clothing providing the display function and the identification information of the plurality of user terminals, and the image data is output in the grouped articles of clothing for each group.

21. The control server of claim 20, wherein the processor generates a temporary address to which the plurality of articles of clothing and the plurality of user terminals are accessible for each group, and transceives for each group at least one of the image data and the signal of the article of clothing with the plurality of articles of clothing and the plurality of user terminals accessing the temporary address for each group.
